(19) United States
(12) Patent Application Publication
(10) Pub. No.: US 2019/0258368 A1
(43) Pub. Date: Aug. 22, 2019

(54) METHODS AND SYSTEMS FOR A DEVICE HAVING A GENERIC KEY HANDLER

(71) Applicant: BOSE CORPORATION, Framingham, MA (US)

(72) Inventors: Ajay Khambadkone, South Grafton, MA (US); Santosh Gondi, Lexington, MA (US); Trevor Irving Lai, Wayland, MA (US)

(21) Appl. No.: 15/901,575

(22) Filed: Feb. 21, 2018

(51) Int. Cl. G06F 3/0484; H04L 12/24

(52) U.S. Cl. CPC G06F 3/0484; G06F 3/0488; H04L 41/0803; H04L 41/22

(57) ABSTRACT

A computer-implemented method includes accessing a first configuration file defining a first key event that associates a first interface interaction with a first intended action; detecting, by an event handling process, a first user input at a user interface; determining whether the first user input corresponds to the first interface interaction; responsive to the first user input corresponding to the first interface interaction, providing an identifier of the first intended action; accessing a second configuration file defining a second key event that associates a second interface interaction with a second intended action; detecting a second user input at the user interface; determining whether the second user input corresponds to the second interface interaction without rebooting the device after accessing the second configuration file; and responsive to the second user input corresponding to the second interface interaction, providing an identifier of the second intended action.

### BACKGROUND

### Technical Field

The application relates generally to processing input from user interface elements of devices, and more particularly, in one example, to processing input received from buttons, keys, or other input elements of a user device, such as a media playback device.

### Background

Users often interact with devices through one or more interface elements, such as keys or buttons. A user may intend that the device take different actions in response to different types of input. For example, pressing a key may elicit a different response than pressing and holding a key, or hovering a finger over the key without pushing it. Different combinations or sequences of keys may also signal different intended actions. An event handler executed by a processor of the device is typically responsible for detecting the user input event. The event handler or another process may then take a particular action in response to the input event.

Different devices may have a different number or type of input elements. In currently available devices, the logic for determining what action to take in response to an input event is part of the firmware of the device, and is written at the hardware level for a particular interface of a particular device. Therefore, developers often must create and debug customized input handlers for each type of device. Furthermore, firmware is a compiled executable component of the device, meaning that the device must be rebooted should any changes be made to the event handling logic. Rebooting a device is a relatively time-consuming process during which the device is non-operational.

### SUMMARY

The examples described and claimed here overcome the drawbacks of presently available devices by employing a non-compiled (e.g., flat file) configuration file that associates particular types of user input with intended actions that can be carried out by the device. The configuration file can be hot-swapped during operation of the device, allowing the device's response to user input to be modified without requiring a reboot of the device. Allowing for unobtrusive updates to the behavior of the device in this manner speeds prototyping and testing of the device in a development environment, and makes for a more seamless user experience in the field.

According to one aspect, a computer-implemented method includes accessing, by a device having a processor and a user interface, a first configuration file defining a first key event that associates a first interface interaction with a first intended action; detecting, by an event handling process executed by the processor of the device, a user input at the user interface; determining whether the user input corresponds to the first interface interaction; responsive to the user input corresponding to the first interface interaction, providing an identifier of the first intended action; accessing, by the device, a second configuration file defining a second key event that associates a second interface interaction with a second intended action; determining whether the user input corresponds to the second interface interaction without rebooting the device after accessing the second configuration file; and responsive to the user input corresponding to the second interface interaction, providing an identifier of the second intended action.

In one example, the first interface interaction and the second interface interaction are performed with at least one input element of the user interface, the at least one input element selected from a group consisting of a button on the device, a key on the device, a touch region on the device, a capacitive sensor on the device, a capacitive region on the device, a button on a remote device communicatively coupled to the device, and a key on the remote device communicatively coupled to the device. In a further example, the first interface interaction and the second interface interaction each comprises an event type, at least one key identifier, and event timing information. In a still further example, the event type is one of a key press, a key press and release, a key press and hold, and a repeated key press and hold. In yet a further example, the at least one key identifier identifies at least one key pressed during the first interface interaction.

According to another example, the method further includes detecting, by the event handling process, the user input at a second user interface. According to another example, the method includes storing the first key event in a hashed data structure, wherein determining whether the user input corresponds to the first interface interaction is performed by accessing the hashed data structure.

According to another aspect, a media playback device includes a user interface, a memory, and a processor configured to access, in the memory, a first configuration file defining a first key event that associates a first interface interaction with a first intended action; detect a user input at the at least one user interface; determine whether the user input corresponds to the first interface interaction; responsive to the user input corresponding to the first interface interaction, provide an identifier of the first intended action; access, in the memory, a second configuration file defining a second key event that associates a second interface interaction with a second intended action; determine whether the user input corresponds to the second interface interaction without rebooting the device after accessing the second configuration file; and responsive to the user input corresponding to the second interface interaction, provide an identifier of the second intended action.

In one example, the first interface interaction and the second interface interaction are performed with at least one input element of the user interface, the at least one input element selected from a group consisting of a button on the media playback device, a key on the media playback device, a touch region on the media playback device, a capacitive region on the media playback device, a button on a remote device communicatively coupled to the media playback device, and a key on the remote device communicatively coupled to the media playback device.

In another example, the first interface interaction and the second interface interaction each includes an event type, at least one key identifier, and event timing information. In a further example, the first interface interaction further comprises an identifier of the respective at least one user interface where the user input is detected. In yet a further example, the event type is one of a key press, a key press and release, a key press and hold, and a repeated key press and hold.

In one example, the processor is further configured to detect the user input at a second user interface. In another example, the processor is further configured to store the first key event in a hashed data structure, wherein determining whether the user input corresponds to the first interface interaction is performed by accessing the hashed data structure. In yet another example, the processor is further configured to access the second configuration file responsive to one of a request by a user and a change in a use context of the media playback device. In another example, the device further includes a communication interface, and the processor is further configured to receive, via the communication interface, at least one of the first configuration file and the second configuration file.

In another aspect, a system includes at least one user interface component, and a device having a processor and a memory. The processor is configured to access a first configuration file defining a first key event that associates a first interface interaction with a first intended action; detect a user input at the at least one user interface component; determine whether the user input corresponds to the first interface interaction; responsive to the user input corresponding to the first interface interaction, provide an identifier of the first intended action; access a second configuration file defining a second key event that associates a second interface interaction with a second intended action; determine whether the user input corresponds to the second interface interaction without rebooting the device after determining whether the user input corresponds to the first interface interaction; and responsive to the user input corresponding to the first interface interaction, provide an identifier of the first intended action.

In one example, the at least one user interface component comprises an input element that is selected from a group consisting of a button, a key, a touch region, and a capacitive region. In another example, the first interface interaction comprises an event type, at least one key identifier, event timing information, and an identifier of the at least one user interface component. In yet another example, the system includes a communication interface, wherein the processor is further configured to receive, via the communication interface, the configuration file.

The examples described here relate generally to controlling media playback devices having user interfaces that include tactile input elements, such as keys, buttons, or touch-sensitive regions such as capacitive buttons or strips. It will be appreciated, however, that these are only examples, and that the methods and systems described here may relate to other types of user interfaces or input elements. In other examples, the user input may be gestures detected by an optical interface, or voice commands detected by an audio interface. Similarly, while the examples here relate to controlling physical devices, the configuration file may also be used to determine how a simulated, software-based interface operates. The techniques described could therefore be used for rapid software prototyping of user interface aspects; once the desired functionality is achieved, the configuration file could then be ported to a physical device to control its operation in the same manner

### BRIEF DESCRIPTION OF DRAWINGS

Various examples are discussed below with reference to the accompanying figures, which are not intended to be drawn to scale. The figures are included to provide an illustration and a further understanding of the various aspects, and are incorporated in and constitute a part of this specification, but are not intended as a definition of the limits of any claim or description. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram of a device according to an example;

FIG. 2 depicts an exemplary data schema according to an example;

FIG. 3 is a block diagram of a system according to an example; and

FIG. 4 is a flow chart of a method for using a device or system according to an example.

### DESCRIPTION

The implementations described and claimed here overcome the drawbacks of known techniques for processing user input. A generic key handler is provided that generically translates input events to intended actions, without regard for the underlying specifics of the device hardware. This approach allows for easy assignment and reassignment of user input events to intended actions through the use of a configuration file. The configuration file relates user input events with intended actions, and is used by the processor to process input events and trigger the intended action. In some examples, the configuration file is a flat text file. This provides the ability to “hot swap” a configuration file for a different (or updated) one without incurring the time cost of rebooting the device. Eliminating the need to reboot the device when changing an input-action relationship is advantageous in a development environment, when user interface development and testing may require iterative changes to the operation of the user interface. The use of a hot-swappable configuration file therefore reduces development time.

The ability to change interface behaviors is also advantageous to the user experience, allowing updated or changed behaviors to be employed without disruption to, or even detection by, the end user of the device. In one exemplary use case, a configuration file may be used to modify or limit the behavior of the user interface during a demonstration mode, such as in a retail environment. Restricting the user's access to some functionality of the device in this manner can ensure a more controlled, positive shopping experience. In another exemplary use case, a configuration file may be used to modify the function of the user interface when the device (e.g., a speaker) becomes part of a group of synchronized devices used for multiroom or group playback. In such situations, if the device is a “slave” in the group, user input received at the device may be forwarded to the master device of the group for processing. Selecting from among multiple configuration files to handle user input depending on the device's role in a group simplifies the process of writing application code for the device.

The use of a configuration file as described here also reduces the need for a customized key handler for each type of device. The generic key handler can be used across devices, with the configuration file customized to the specifics of each device. This promotes efficiency, as the developer is not “reinventing the wheel” by developing a custom key handler for each device, and can instead focus on the features of the device. The generic key handler allows for consistency across device offerings; similar behaviors for similar inputs can be easily set (and re-set as desired) across devices. To that end, the generic key handler and one or more configuration files can be packaged as a library for use by different development teams.

In one example, a device includes at least a user interface, a memory, and a processor. The processor can access a non-compiled (e.g., flat text) configuration file stored in the memory. The configuration file associates one or more user input events (i.e., interface interactions) with one or more respective intended actions. Each input-action association may include one or parameters that are set in the configuration file. For example, the configuration file may define a user input event as involving a particular single key, or a sequence or combination of keys. Some devices may have more than one user interface, such as a row of keys on the device, as well as a remote control for the device. In another example, the device may be part of a system with other devices having user interfaces, with input events being detected at the user interfaces of those devices and handled by the device. Events may be detected at each interface as they occur, with dedicated event handler processes “listening” for events at each interface. Detected events may be passed to the generic key handler process. The configuration file for such multi-interface devices may define input events in part according to which interface they originated at. The configuration file may also define an input event according to the type of interaction the user has with a key or other input element, such as whether the user pushed and released the key, pushed and held the key, repeatedly pushed and released the key, swiped across a region, etc. Relatedly, the configuration file may define how long a key must be pushed in order to register such a “push and hold” event.

In addition to defining an input event, the configuration file defines one or more actions to be taken when that input event occurs. For example, an identifier (such as a string or numeral) of an action may be provided to an event handler or other process, which in turn takes an action corresponding to the identifier.

Should it become necessary or desirable to change the behavior of the user interface, such as during testing or development of the user interface, the configuration file can be modified, or a new one swapped in for the current version. The key handler begins handling input events according to the definitions in the new configuration file without requiring a reboot of the device.

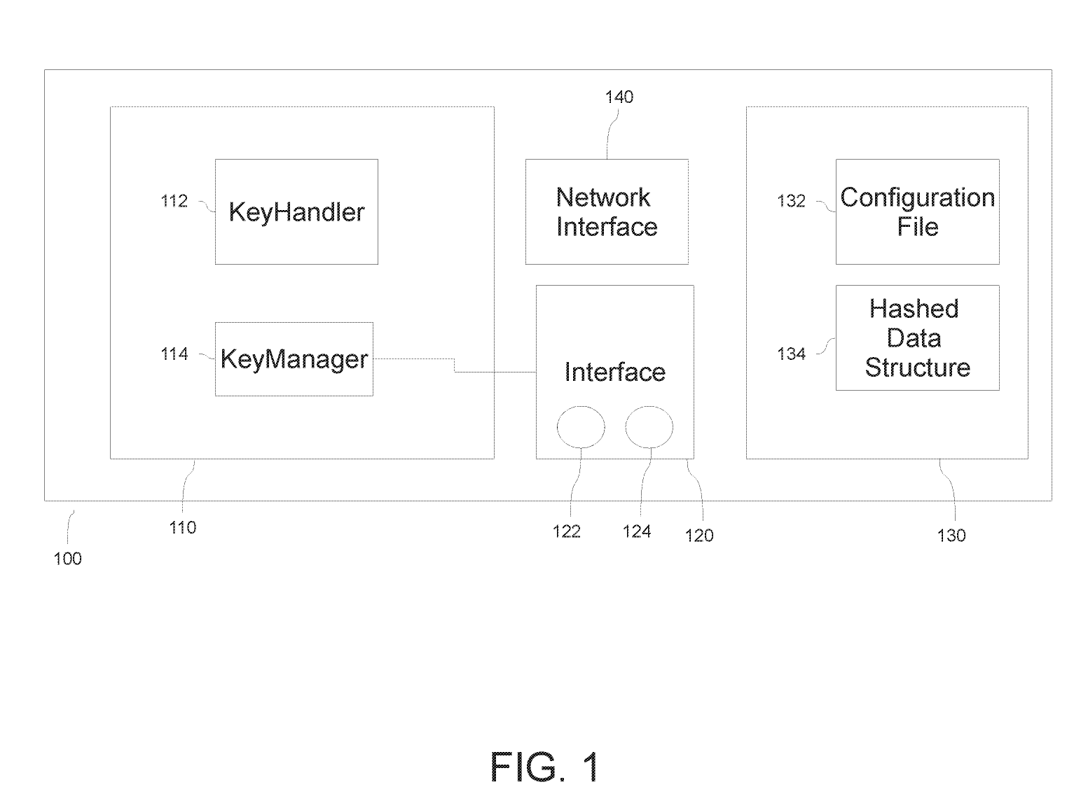

FIG. 1 shows a device 100 according to one example. The device 100 includes a processor 110 that executes processes including a keyhandler 112 and at least one keymanager 114. The keymanager 114 detects input received at an interface 120, which may include one or more input elements 122, 124, such as touch keys, buttons, etc. A memory 130 is further provided. The memory 130 is configured to store at least one configuration file 132 that defines associations between user input events and intended actions, as described in more detail below. In some examples, the memory 130 also stores a hashed data structure 134. The hashed data structure 134 stores the associations from the configuration file 132 in a manner that allows for quick access and determination of an intended action responsive to a detected user input. In some examples, the device further includes a network interface 140. The network interface 140 is configured to allow for communication between the device 100 and other devices or systems. For example, the network interface 140 may allow the device 100 to receive the configuration file 132 from another device or system. The network interface 140 may also allow the device 100 to access other data necessary for operation of the device 100, such as audiovisual content in the case of the device 100 being a media playback device.

The device 100 may include other elements not shown in FIG. 1. For example, a media playback device may include a speaker, a microphone, and/or a visual display.

The interface 120 is configured to detect input from a user via one or more input elements 122,124. The input elements 122, 124 may be physically actuatable elements, such as buttons or keys, or may be sensors capable of detecting touch or other input. For example, the input elements 122, 124 may each be a button, a key, a touch region, or a capacative sensor having one or more regions. The input elements 122, 124 may be physically disposed on the device, or may be located on a remote control (not shown). The interface 120 may be configured to communicate user input events to the processor 110 directly, such as through a physical circuit connecting the interface 120 and the processor 110. In another example, the interface 120 may communicate with the processor 110 using radio frequency (RF), optical, infrared (IR), consumer electronic control (CEC), web socket, Bluetooth, or other medium or protocol. In some examples, at least one of the input elements 122, 124 may be stacked with a display element (e.g., a LED), such that the appearance of the input element 122, 124 can be changed responsive to the state of the device 100, the user input, or for other reasons.

The processor 110 may run firmware or other software to control at least some operations of the device 100, including its operation and interaction with other components, devices, or systems. The keymanager 114 monitors the interface 120 to detect a user input event, and obtains information about the user input event. This information may include information about the input element 122, 124 at which the user input was received; the type of interaction, such as whether a button was pushed and released, pushed and held for some duration, or repeatedly pushed and released; the amount of time that the button was pushed and/or released. Other information, such as the force applied to the input element 122, 124, may also be detected.

Upon being notified of an input event, the keyhandler 112 determines, with reference to the configuration file 132, whether there is an intended action associated with the input event detected. If so, the processor executes the intended action. The intended action may include, for example, starting or stopping playback of media; turning on or off a microphone of the device 100; connecting or disconnecting a network connection; changing the volume of media being played back; or any other action the device 100 is configured to perform. Along with the intended action, the processor may execute one or more additional processes, such as change to the display of the device 100, issuing an audible cue, or the like.

The keyhandler 112 executing on the processor 110 receives information about the user input event from the keymanager 114, and uses that information to determine an intended action, if any, that the processor 110 should execute in response. The determination is made with reference to the input-action associations provided in the configuration file 132 stored in the memory 130 of the device 100. In one example, the input-action associations are stored in the hashed data structure 134, which may be implemented as an array data type that maps keys to values. The processor 110 may execute a hash function on the hashed data structure 134 to compute an index from which the desired value can be found, which may increase the speed with which the input-action associations can be accessed. The keyhandler 112 may therefore access the hashed data structure 134 directly, rather than the configuration file 132. For purposes of illustration, however, the discussion here will involve the keyhandler 112 accessing the input-action associations in the configuration file 132, though either approach may be acceptable.

The keyhandler 112 accesses the input-action associations in the configuration file 132 to determine what intended action, if any, should be taken in response to a particular interaction with one or more particular input elements.

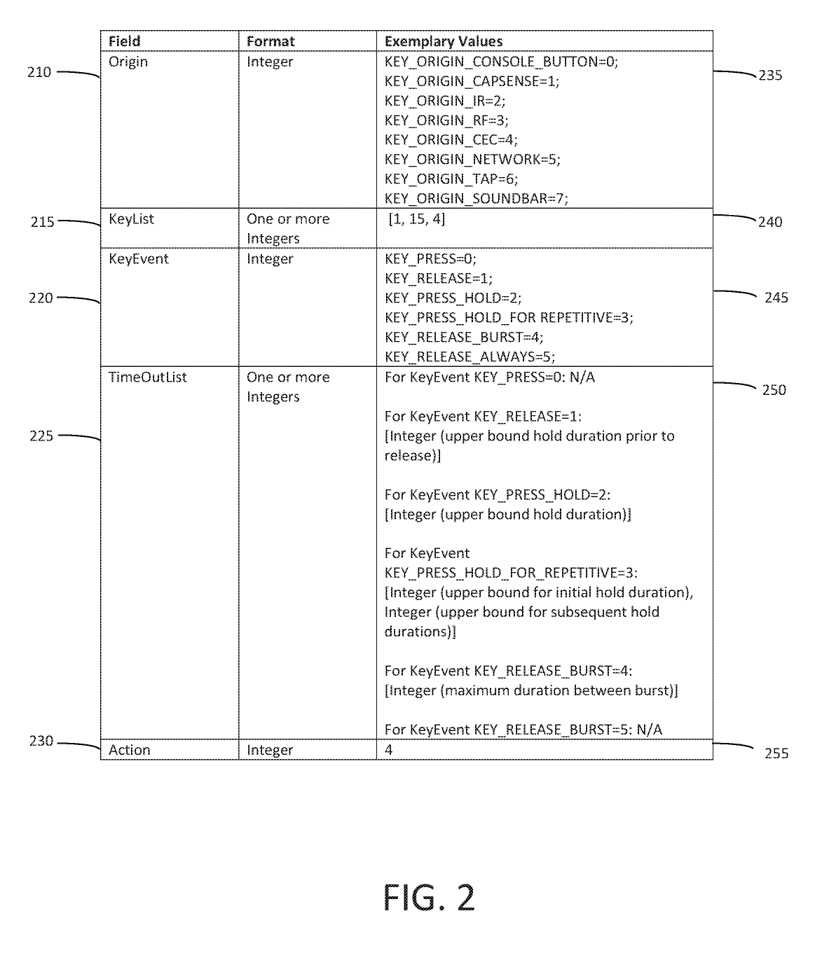

An exemplary schema 200 for defining input-action associations in the configuration file 132 is shown in FIG. 2. During operation of the device 100, user input events are detected and compared to the input-action associations in the configuration file 132 in order to determine what, if any, action to take in response to the input event. The schema 200 illustrates the types and formats of information used to define one event-action association. A configuration file 132 may include a number of such associations, however, defining different actions to be taken in response to different user input events.

As shown, in FIG. 2, an event may be defined by a number of fields 210-230, including Origin 210 (e.g., the user interface or region at which the user input was detected), KeyList 215 (e.g., the one or more input elements at which the user input was detected), the KeyEvent 220 (e.g., the type of interaction with the input element, such as whether a key was pressed and released, pressed and held, repeatedly pressed, or repeatedly pressed and held); and TimeOutList 225 (e.g., the durations of time that define whether a key was pressed and released as opposed to pressed and held, whether the key was repeatedly pressed or simply pressed a single time in multiple interactions, etc.). The configuration file 132 may also associate an Action 230 with the event.

Each of the fields 210-230 is defined by one or more values, which may be represented by one or more numeric values 235-255. In some examples, the fields 210-230 may be defined by a numeric value (e.g, 0), or alternately by a constant name (e.g., ORIGIN_CONSOLE_BUTTON) that is an equivalent of the numeric value, in order to improve readability and accuracy for users creating or modifying the configuration file 132.

The Origin 210 defines, for a user input event, the location of the input element. The Origin 210 may store a value 235 reflecting whether the input event was detected at a button, key, or capacitive sensor on the device 100 itself, or at another device communicating with the device through IR, RF, CEC, or the network interface 140. For example, the Origin 210 may identify that the input event occurred at a soundbar or other media device associated with the device 100.

The KeyList 215 defines the one or more input elements involved in the user input event. If the event involves a single button being pushed, for example, the value 240 may include a single value (e.g., an Integer) identifying the button. If the event involves a combination of input elements (e.g., keys) being pushed simultaneously or in a sequence, the KeyList may include an identifier of each input element involved. For example, the KeyList 215 may be defined as an ordered set, an unordered set, or an array.

The KeyEvent 220 defines the type of interaction the user has had with the input element. For example, where the input element is a key, the value 245 for the KeyEvent 220 may identify the event according to whether a key is pressed and released, pressed and held, repeatedly pressed, or repeatedly pressed and held. In some examples, multiple KeyEvents 220 may be encompassed by a particular user input, and a hierarchy may be established for handling the event. For example, a use case in which a user presses and quickly releases a button may be capable of triggering any one or more of a KEY_PRESS, KEY_RELEASE, and KEY_RELEASE_ALWAYS event. In that situation, the associations provided in the configuration file may determine which event(s) occur. In one example, the KEY_RELEASE event may not be triggered if an action has already been determined for KEY_PRESS for that interaction. However, the KEY_RELEASE_ALWAYS event may always be triggered, regardless of whether an action has been determined for the KEY_PRESS event.

The TimeOutList 225 defines the threshold durations of time that are used to discern one type of interaction from another, such as whether a key was pressed and released as opposed to pressed and held, whether the key was repeatedly pressed or simply pressed a single time in multiple interactions, etc. The TimeOutList 225 may include one or more values for each of the values 245 for KeyEvent 220. For example, for a KeyEvent 220 of KEY_PRESS_HOLD, the corresponding value 250 in the TimeOutList 225 may be the number of milliseconds representing the upper bound of time during which the button is depressed. A configuration file 132 (FIG. 1) may include multiple input-action associations involving the same key and the same event; the TimeOutList 225 can be used to allow for different actions to be taken when that key is held for different amounts of time. Similarly, input-action associations may be defined in the configuration file 132 according to whether the user has repeatedly pushed the key in a quick burst (i.e., with a relatively short delay between pushes) or a slower burst (i.e., with a relatively longer delay between pushes).

The Action 230 associated with the user input may be represented by a value 255 that uniquely identifies to the processor 110 an action to be taken when the user input event defined by Fields 210-230 occurs.

Returning to FIG. 1, the keyhandler 112, upon receiving a notification from the keymanager 114 that an input event has been detected, can determine whether the input event matches any of the input-action associations provided in the configuration file. If so, the associated action can be carried out by the processor 110 with reference to the action identifier stored in the input-action association. In another example, the action identifier may be passed to another device or system that will carry out the intended action. If a user input is detected that matches none of the input-action associations in the configuration file, the processor 110 responds gracefully by either ignoring the input, or by indicating (such as through an audible tone or flashing display) that the input is not recognized.

In some examples, the configuration file and/or the associations provided therein may be validated by the device 100 or by another device or system prior to being loaded on the device 100. A particular structure or format may be enforced. For example, the device 100 may require that the KeyList is in ascending order. In another example, the device 100 may require that the Origin field and the KeyEvent field are each within an expected range of values. In another example, the device 100 may require that a particular user input will trigger only one event. For example, the device 100 may disallow an association for a particular key combination with KEY_PRESS_HOLD where an association is also defined for that particular key combination for KEY_PRESS_HOLD_FOR_REPETITIVE. The configuration file may also be examined for well-formedness, such as validating that all input-action associations are correctly paired, all parentheses and brackets are matched and properly nested, and so forth.

Should one or more of the validity requirements not be met, the device 100 may issue an indication, such as an error code or an indication on the interface 120 (e.g., lights flashing in a predetermined error pattern).

Referring still to FIG. 1, the network interface 140 allows the device 100 to communicate with one or more other devices via protocols including 3G, 4G, Bluetooth, or Wifi. In some examples, the other devices may be part of a cloud computing network. The device 100 may access the configuration file 132 over the network interface 140 from another device or a remote server.

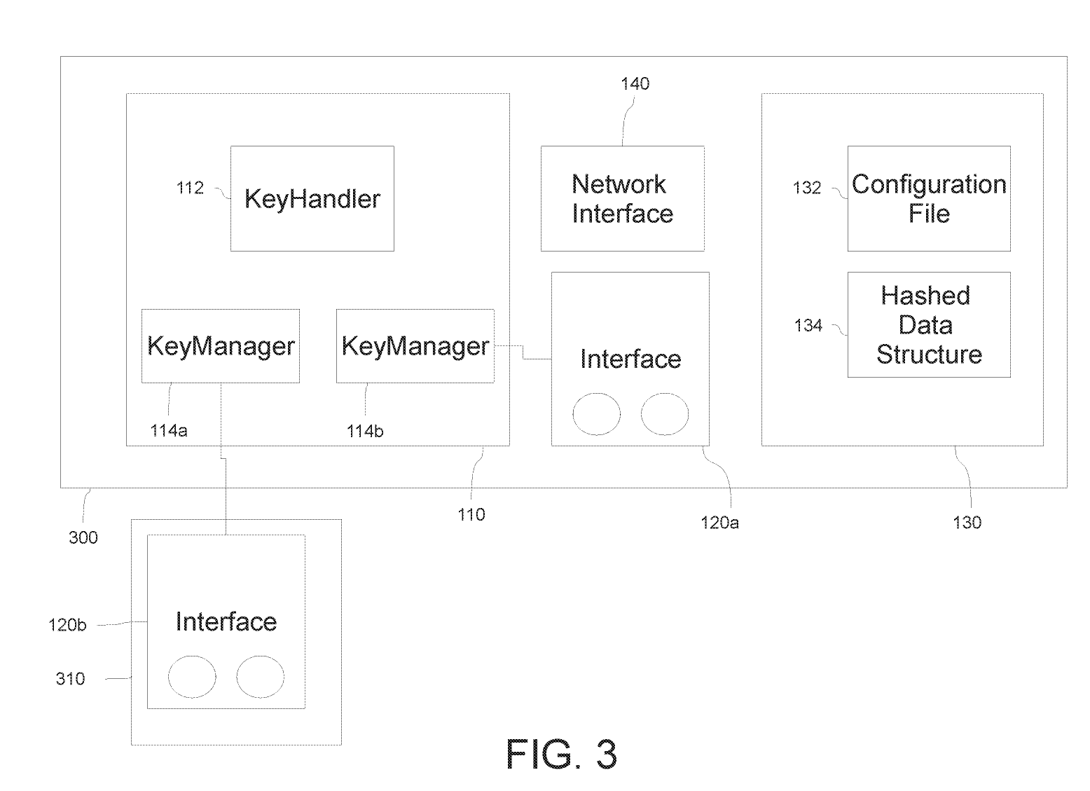

In some examples, the device 100 may incorporate or be in communication with multiple user interfaces. One such example device 300 can be seen in FIG. 3. The components of the device 300 function similarly to those of device 100, except that the processor 110 may execute a dedicated keymanager for each interface. For example, keymanager 114a may be configured to detect user input at a first interface 120a, and keymanager 114b may be configured to detect user input at a second interface 120b. Each of the keymanagers 120a,b, upon detecting a user input event at its respective user interface, provides an indication of the event to the keyhandler 112.

An input event may be defined in the configuration file 132 according to whether it is detected at the first interface 120a or the second interface 120b. In particular, the Origin 220 field (shown in the schema of FIG. 2) may define which of the user interfaces 120a,b is associated with the input event.

The arrangement of user interfaces 114a,b shown in FIG. 3 is exemplary. In the example shown, the first interface 120a is part of the device 100, whereas the second interface 120b is part of a second device 310. It will be appreciated, however, that user input may be detected by any number of user interfaces on any number of devices using a respective keymanager process.

In some examples, the memory 130 may be configured to store more than one configuration file 132. Different configuration files 132 may be used in different operating contexts of the device 100. The memory 130 may also store a current configuration file 132, along with any previously or subsequently stored configuration files. The processor 110 may provide a user with an opportunity to select a configuration file to use from among multiple files.

An exemplary method of operating a device (e.g., device 100 or 300) will now be described. In the method, the device accesses a first configuration file containing at least one input-action association. Subsequently, the device detects user input at a user interface, and determines whether that input corresponds to an input-action association provided in the first configuration file. If so, the intended action associated with the input is identified, and can be performed by the device. A second configuration file is then loaded and/or accessed by the device, possibly defining additional or different input-action associations. Again, the device detects user input at a user interface, and this time determines whether that input corresponds to an input-action association provided in the second configuration file. If so, the intended action associated with the input is identified, and can be performed by the device.

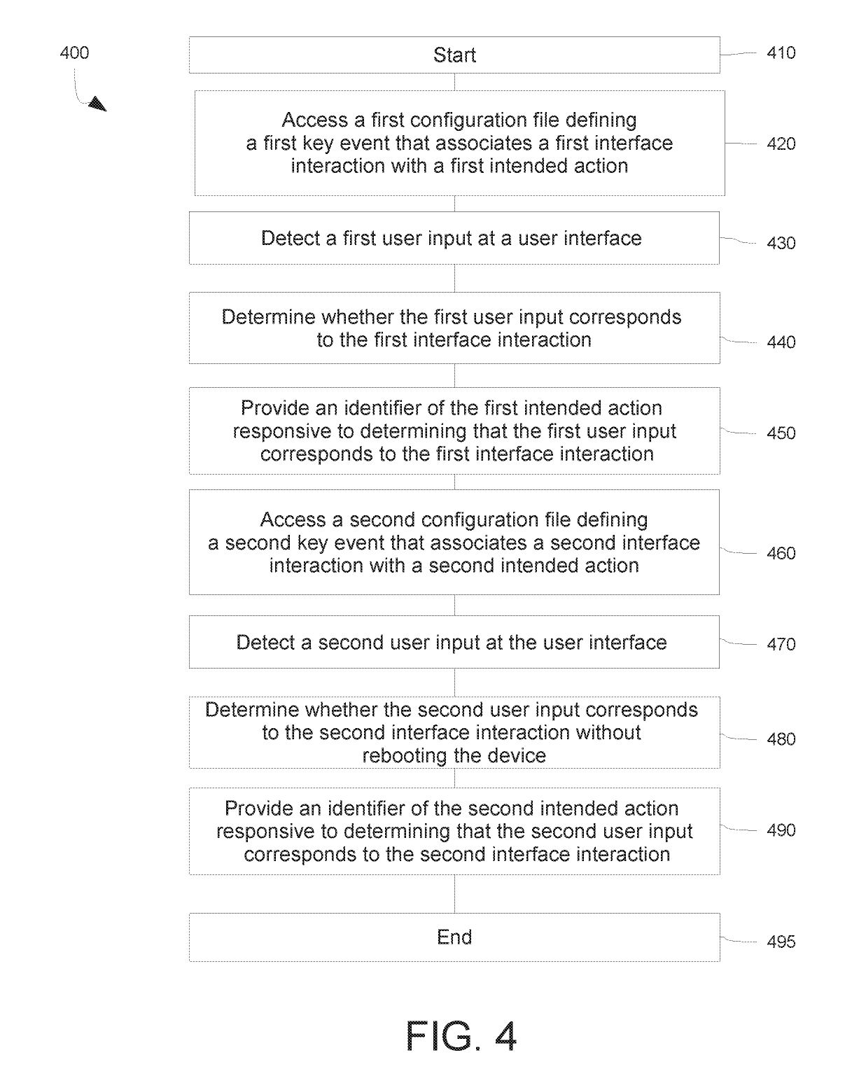

The method 400 shown in FIG. 4 begins at step 410.

At step 420, a device having a processor and a user interface accesses a first configuration file defining a first key event that associates a first interface interaction with a first intended action. The device (e.g., device 100) may access the first configuration file from a memory of the device. The first configuration file may store information associating the first interface interaction with the first intended action in the format of the schema shown in FIG. 2 and described in the accompanying description above. The device may validate or otherwise process the association information when it is first accessed. For example, the device may confirm that the definitions of the associations are well-formed, and do not result in undesirable activity such as more than one action being associated with a particular interaction. The device may also load the associations into a hashed data structure for more efficient retrieval in later steps.

At step 430, an event handling process executed by the processor of the device detects a first user input at the user interface. The event handling process may be an event listener. Information about the user input may be determined, such as the interface at which the user input occurred; the input element(s) (e.g., button(s)) involved; the duration and type of the interaction, and so on.

At step 440, it is determined whether the first user input corresponds to the first interface interaction. As an initial matter, the device may arrange the information about the user input into the format followed by the configuration file, allowing for more efficient and direct comparison between the detected user input and the one or more associations defined in the configuration file. In an example where the association information from the configuration file is stored in a hashed data structure, the detected user input, after being formatted by the device, may also be hashed to allow for comparison with entries in the hashed data structure.

At step 450, an identifier of the first intended action is provided responsive to the first user input corresponding to the first interface interaction. For example, the identifier may be provided to another process being executed by the processor. The processor may determine the intended action associated with the identifier, such as by referring to a lookup table. The processor may then execute the intended action. In another example, the identifier may be provided to an external device or system, such as by the processor transmitting the identifier via the network interface 140.

At step 460, the device accesses a second configuration file defining a second key event that associates a second interface interaction with a second intended action. The second configuration file may have been previously stored in a memory of the device, or may have been stored on the device subsequent to the first configuration file being stored. For example, in one use case, as part of the development process for the user interface of the device, a developer may determine that a change to the first configuration file should be made, and may make the necessary change in the second configuration file, which is then stored on the device. In some examples, the first configuration file and the second configuration file may coexist on the device. In other examples, the second configuration file may overwrite the first configuration file, or otherwise cause the first configuration file to be unavailable.

In another use case, the second configuration file may be selected to replace the first configuration file during use of the device, causing the associations defined in the second configuration file to take precedence. The selection may be made by a user of the device; for example, the user may be given the opportunity to control the operation of the user interface by selecting from among multiple configuration files, or by modifying an existing one. The selection may also be made automatically by the device, or may be made by a remote device that causes the second configuration file to be loaded onto the device and used, such as part of a software upgrade for the device. In another example, the device may detect that the user is pushing a key on the user interface repeatedly, but is not doing so quickly enough to cause the device to detect a KEY_RELEASE_BURST event, as discussed with respect to FIG. 2. The device may therefore determine that the user is intending to trigger the action associated with the KEY_RELEASE_BURST event, but is unable to do so, due to dexterity or coordination issues. The device may therefore attempt to accommodate the user by automatically accessing a second configuration file with a higher upper bound duration for triggering a KEY_RELEASE_BURST event. In yet another example, the device may selectively access one of multiple configuration files based on a current user of the device, which may be determined by the currently logged-in user of the device, or on the assumed proximity of a particular user to the device, based on the location of their mobile device.

At step 470, the event handling process executed by the processor of the device detects a second user input at the user interface, much as described with respect to step 430.

At step 480, it is determined whether the user input corresponds to the second interface interaction without rebooting the device after accessing the second configuration file. After accessing the second configuration file in step 460, the second configuration file is hot-swapped for the first configuration file, with the processor immediately beginning to use the associations stored therein to determine whether a user input is associated with an intended action. In an example where a hashed data structure is used, the hashed data structure may be emptied after step 450, and recreated with the associations from the second configuration file. Because the configuration file is not part of the compiled firmware of the device, a reboot of the device is not necessary.

At step 490, an identifier of the second intended action is provided responsive to the user input corresponding to the second interface interaction, much in the same way as described with respect to step 450.

At step 495, the method ends.

As discussed above, aspects and functions disclosed herein may be implemented as hardware or software on one or more of these computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers. Additionally, aspects may be performed on a client-server or multi-tier system that includes components distributed among one or more server systems that perform various functions. Consequently, examples are not limited to executing on any particular system or group of systems. Further, aspects may be implemented in software, hardware or firmware, or any combination thereof. Thus, aspects may be implemented within methods, acts, systems, system elements and components using a variety of hardware and software configurations, and examples are not limited to any particular distributed architecture, network, or communication protocol.

The computer devices described herein are interconnected by, and may exchange data through, a communication network. The network may include any communication network through which computer systems may exchange data. To exchange data using the network, the computer systems and the network may use various methods, protocols and standards, including, among others, Fibre Channel, Token Ring, Ethernet, Wireless Ethernet, Bluetooth, Bluetooth Low Energy (BLE), IEEE 802.11, IP, IPV6, TCP/IP, UDP, DTN, HTTP, FTP, SNMP, SMS, MMS, SS7, JSON, SOAP, CORBA, REST and Web Services. To ensure data transfer is secure, the computer systems may transmit data via the network using a variety of security measures including, for example, TSL, SSL or VPN.

The computer systems include processors that may perform a series of instructions that result in manipulated data. The processor may be a commercially available processor such as an Intel Xeon, Itanium, Core, Celeron, Pentium, AMD Opteron, Sun UltraSPARC, IBM Power5+, or IBM mainframe chip, but may be any type of processor, multiprocessor or controller.

A memory may be used for storing programs and data during operation of the device. Thus, the memory may be a relatively high performance, volatile, random access memory such as a dynamic random access memory (DRAM) or static memory (SRAM). However, the memory may include any device for storing data, such as a disk drive or other non-volatile storage device. Various examples may organize the memory into particularized and, in some cases, unique structures to perform the functions disclosed herein.

As discussed, the devices 100, 300, or 310 may also include one or more interface devices such as input devices and output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system to exchange information and communicate with external entities, such as users and other systems.

Data storage may include a computer readable and writeable nonvolatile (non-transitory) data storage medium in which instructions are stored that define a program that may be executed by the processor. The data storage also may include information that is recorded, on or in, the medium, and this information may be processed by the processor during execution of the program. More specifically, the information may be stored in one or more data structures specifically configured to conserve storage space or increase data exchange performance. The instructions may be persistently stored as encoded signals, and the instructions may cause the processor to perform any of the functions described herein. The medium may, for example, be optical disk, magnetic disk or flash memory, among others. In operation, the processor or some other controller may cause data to be read from the nonvolatile recording medium into another memory, such as the memory, that allows for faster access to the information by the processor than does the storage medium included in the data storage. The memory may be located in the data storage or in the memory, however, the processor may manipulate the data within the memory, and then copy the data to the storage medium associated with the data storage after processing is completed. A variety of components may manage data movement between the storage medium and other memory elements and examples are not limited to particular data management components. Further, examples are not limited to a particular memory system or data storage system.

Various aspects and functions may be practiced on one or more computers having a different architectures or components than that shown in the figures. For instance, one or more components may include specially programmed, special-purpose hardware, such as for example, an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

One or more components may include an operating system that manages at least a portion of the hardware elements described herein. A processor or controller may execute an operating system which may be, for example, a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, an Android operating system available from Google, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular implementation.

The processor and operating system together define a computer platform for which application programs in high-level programming languages may be written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Thus, functional components disclosed herein may include a wide variety of elements, e.g. executable code, data structures or objects, configured to perform described functions.

What is claimed is:

1. A computer-implemented method comprising:
accessing, by a device having a processor and a user interface, a first configuration file defining a first key event that associates a first interface interaction with a first intended action;
detecting, by an event handling process executed by the processor of the device, a first user input at the user interface;
determining whether the first user input corresponds to the first interface interaction;
responsive to the first user input corresponding to the first interface interaction, providing an identifier of the first intended action;
accessing, by the device, a second configuration file defining a second key event that associates a second interface interaction with a second intended action;
detecting, by the event handling process executed by the processor of the device, a second user input at the user interface;
determining whether the second user input corresponds to the second interface interaction without rebooting the device after accessing the second configuration file; and
responsive to the second user input corresponding to the second interface interaction, providing an identifier of the second intended action.

2. The computer-implemented method of claim 1, wherein the first interface interaction and the second interface interaction are performed with at least one input element of the user interface, the at least one input element selected from a group consisting of a button on the device, a key on the device, a touch region on the device, a capacitive sensor on the device, a capacitive region on the device, a button on a remote device communicatively coupled to the device, and a key on the remote device communicatively coupled to the device.

3. The computer-implemented method of claim 2, wherein the first interface interaction and the second interface interaction each comprises an event type, at least one key identifier, and event timing information.

4. The computer-implemented method of claim 3, wherein the event type is one of a key press, a key press and release, a key press and hold, and a repeated key press and hold.

5. The computer-implemented method of claim 3, wherein the at least one key identifier identifies at least one key pressed during the first interface interaction.

6. The computer-implemented method of claim 1, further comprising detecting, by the event handling process, one of the first and second user inputs at a second user interface.

7. The computer-implemented method of claim 1, further comprising storing the first key event in a hashed data structure, wherein determining whether the first user input corresponds to the first interface interaction is performed by accessing the hashed data structure.

8. A media playback device comprising:
a user interface;
a memory; and
a processor configured to:
access, in the memory, a first configuration file defining a first key event that associates a first interface interaction with a first intended action;
detect a first user input at the at least one user interface;
determine whether the first user input corresponds to the first interface interaction;
responsive to the first user input corresponding to the first interface interaction, provide an identifier of the first intended action;
access, in the memory, a second configuration file defining a second key event that associates a second interface interaction with a second intended action;
detect a second user input at the at least one user interface;
determine whether the second user input corresponds to the second interface interaction without rebooting the device after accessing the second configuration file; and
responsive to the second user input corresponding to the second interface interaction, provide an identifier of the second intended action.

9. The media playback device of claim 8, wherein the first interface interaction and the second interface interaction are performed with at least one input element of the user interface, the at least one input element selected from a group consisting of a button on the media playback device, a key on the media playback device, a touch region on the media playback device, a capacitive region on the media playback device, a button on a remote device communicatively coupled to the media playback device, and a key on the remote device communicatively coupled to the media playback device.

10. The media playback device of claim 8, wherein the first interface interaction and the second interface interaction each comprises an event type, at least one key identifier, and event timing information.

11. The media playback device of claim 10, wherein the first interface interaction further comprises an identifier of the respective at least one user interface where the first user input is detected.

12. The media playback device of claim 10, wherein the event type is one of a key press, a key press and release, a key press and hold, and a repeated key press and hold.

13. The media playback device of claim 8, wherein the processor is further configured to detect one of the first and second user inputs at a second user interface.

14. The media playback device of claim 8, wherein the processor is further configured to store the first key event in a hashed data structure, wherein determining whether the first user input corresponds to the first interface interaction is performed by accessing the hashed data structure.

15. The media playback device of claim 8, wherein the processor is further configured to access the second configuration file responsive to one of a request by a user and a change in a use context of the media playback device.

16. The media playback device of claim 8, further comprising a communication interface, wherein the processor is further configured to receive, via the communication interface, at least one of the first configuration file and the second configuration file.

17. A system comprising:
at least one user interface component; and
a device having a processor and a memory, the processor configured to:
access a first configuration file defining a first key event that associates a first interface interaction with a first intended action;
detect a first user input at the at least one user interface component;
determine whether the first user input corresponds to the first interface interaction;
responsive to the first user input corresponding to the first interface interaction, provide an identifier of the first intended action;
access a second configuration file defining a second key event that associates a second interface interaction with a second intended action;
detect a second user input at the at least one user interface component;
determine whether the second user input corresponds to the second interface interaction without rebooting the device after determining whether the user input corresponds to the first interface interaction; and
responsive to the second user input corresponding to the first interface interaction, provide an identifier of the first intended action.

18. The system of claim 17, wherein the at least one user interface component comprises an input element that is selected from a group consisting of a button, a key, a touch region, and a capacitive region.

19. The system of claim 17, wherein the first interface interaction comprises an event type, at least one key identifier, event timing information, and an identifier of the at least one user interface component.

20. The system of claim 17, further comprising a communication interface, wherein the processor is further configured to receive, via the communication interface, the configuration file.
